(19) United States
(12) Patent Application Publication
(10) Pub. No.: US 2002/0143723 A1
(43) Pub. Date: Oct. 3, 2002

(54) Personal data assistant (PDA) using a remote server for processing

(76) Inventor: Wen-Sung Tsai, Taipei (TW)

Correspondence Address: NAIPO (NORTH AMERICA INTERNATIONAL PATENT OFFICE), P.O. BOX 506, MERRIFIELD, VA, 22116, US

(21) Appl. No.: 09/682,484

(22) Filed: Sep. 7, 2001

(30) Foreign Application Priority Data
Mar. 30, 2001 (TW) 090107623

(51) Int. Cl. G06F 7/00

(52) U.S. Cl. 707/1

(57) ABSTRACT

A personal data assistant (PDA) that is connected to a server via a network. The server has application programs. The PDA has a housing, a memory installed in the housing for storing programs and data, a processor electrically connected to the memory for executing the programs stored in the memory, a display panel installed on the housing for displaying data, and an input device for inputting data. The PDA can send a file to the server via the network. The server can then open the file using a corresponding application program and send a picture image of the opened file back to the PDA.

### BACKGROUND OF INVENTION

1. Field of the Invention

The present invention relates to a Personal Data Assistant (PDA), and more particularly, a PDA using a remote server for processing. A PDA user can open/edit files stored in the PDA by using application programs that are installed in a remote server and correspond to the files.

2. Description of the Prior Art

PDA's are becoming more and more popular due to their being small, light, and mobile. A PDA can assist a person in recording addresses, telephone numbers, daily schedules, personal memos, and so on. However, the PDA is restricted by its application programs, because some files that can be opened/edited by application programs installed in a PC can not be opened/edited by application programs installed in a PDA.

For example; a PDA user receives an e-mail in their PDA and a PowerPoint file is attached to the e-mail. It is possible that the user can not open the PowerPoint file in his PDA, because there is no corresponding application program in his PDA. Another example is when a PDA user receives a file and opens the file in the PDA, but can not edit the file in the PDA. In such cases, and according to the prior art, the user must find a PC, upload the files to the PC, then open and edit the files. After finishing editing, the user then downloads the updated files from the PC to the PDA.

Please refer to FIG. 1. FIG. 1 is a diagram of a PDA 10 and a computer 40 according to the prior art. The PDA 10 comprises a housing 12, a display panel 22 installed on the housing 12, and an input device 24. The PDA 10 is connected to the computer 40 through a wire 30.

Please refer to FIG. 2. FIG. 2 is a block diagram for illustrating the connection between the PDA 10 and the computer 40 shown in FIG. 1. The PDA 10 further comprises a memory 14 for storing application programs 16 and files 18, and a processor 20 electrically connected to the memory 14 for executing the application programs 16. The computer 40 comprises a plurality of application programs 44 and a plurality of files 42. Some of the files 18 received by and stored in the PDA 10 can be opened/edited in the PDA 10 by application programs 16, but some can not.

When a user receives a file that can not be opened/edited in the PDA 10, the user must send the file through the wire 30 to the computer 40. Then, the user must open/edit the file by a corresponding application program of programs 44 in the computer 40. After finishing the editing, the user then downloads the updated file from the computer 40 back to the PDA 10. If the computer 40 is not near the user, it can be inconvenient for the user to search for a computer to use.

### SUMMARY OF INVENTION

It is therefore a primary objective of the present invention to provide a PDA using a remote server for processing. When a file stored in the PDA can not be opened or edited, a PDA user can open/edit this file in the PDA by using an application program that is installed in the remote server and corresponds to the file.

According to the claimed invention, the PDA is connected to a server via a network, and the server stores a plurality of application programs for helping to open/edit files that can not be opened/edited in the PDA. The PDA comprises a housing, a memory installed in the housing, a processor electrically connected to the memory, a display panel installed on the housing, and an input device. The PDA is capable of sending a file to the server via the network, the file is then displayed on the display panel of the PDA and is opened/edited by a corresponding application program stored in the server.

It is an advantage of the present invention that the PDA using a remote server for processing is capable of opening/editing a file in the PDA by using a corresponding application program which is installed in the remote server.

These and other objectives of the present invention will no doubt become obvious to those of ordinary skill in the art after reading the following detailed description of the preferred embodiment which is illustrated in the various figures and drawings.

### BRIEF DESCRIPTION OF DRAWINGS

FIG. 1 is a diagram showing a PDA and a computer according to the prior art.

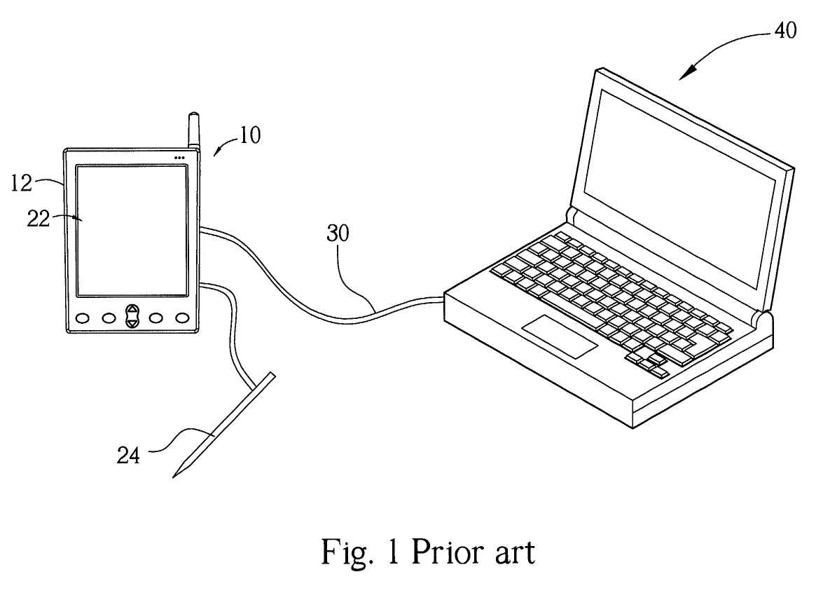

FIG. 2 is a block diagram illustrating a connection between the PDA and the computer shown in FIG. 1.

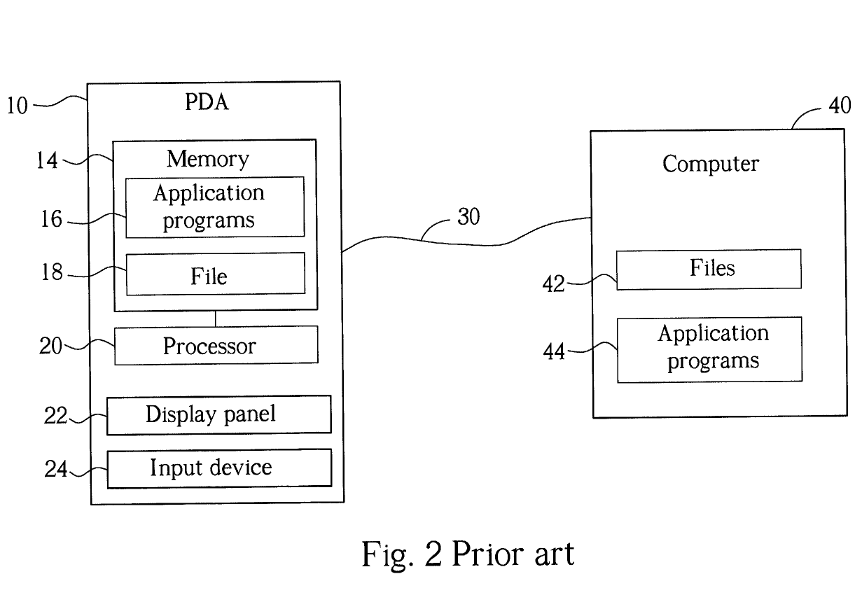

FIG. 3 is a diagram showing a PDA and a server according to the present invention.

FIG. 4 is a block diagram illustrating a connection between the PDA and the computer shown in FIG. 3.

### DETAILED DESCRIPTION

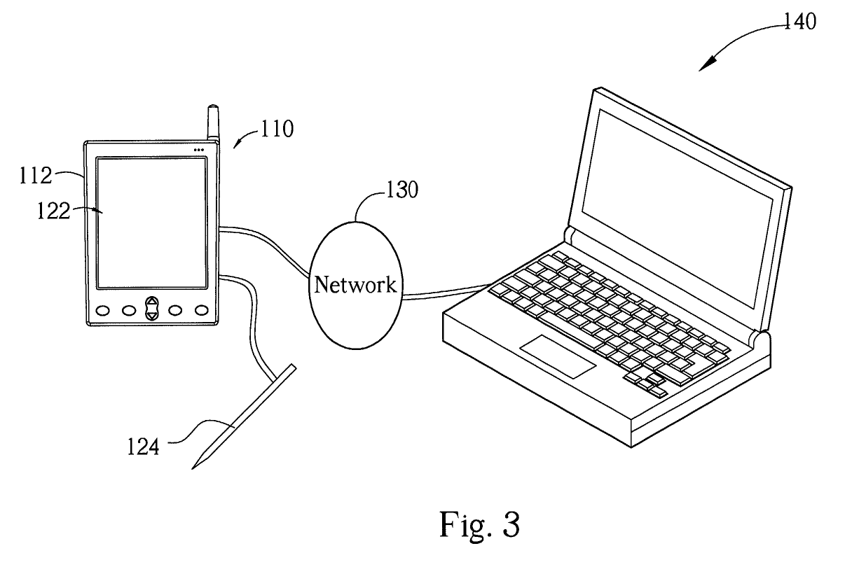

Please refer to FIG. 3. FIG. 3 is a diagram showing a PDA 110 according to the present invention and a server 140. The PDA 110 is connected to the server 140 via a network 130 (the network 130 may be Internet). The PDA 110 comprises a housing 112, a display panel 122 installed on the housing 112, and an input device 124.

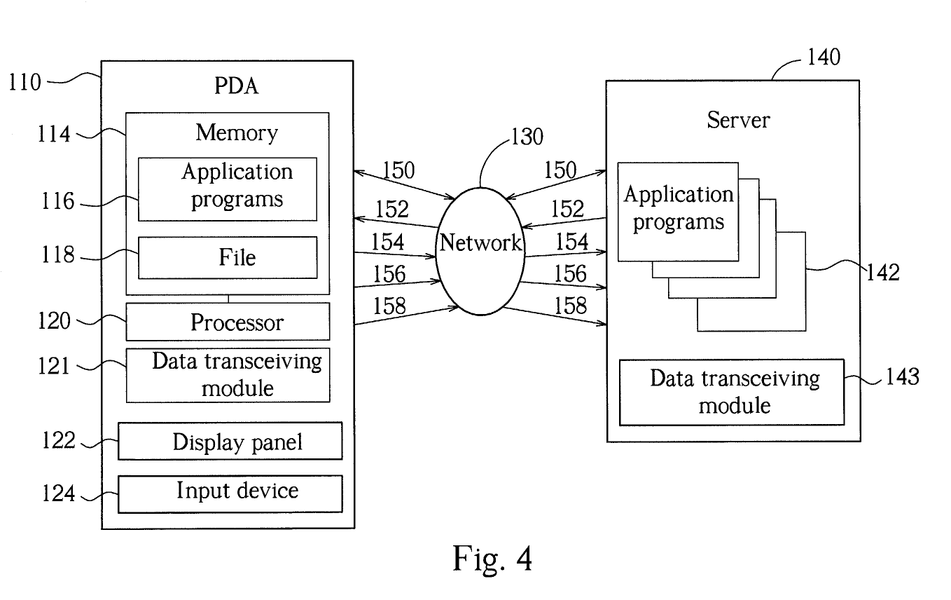

Please refer to FIG. 4. FIG. 4 is a block diagram illustrating the connection between the PDA 110 and the server 140 shown in FIG. 3. The PDA 110 further comprises a memory 114 (the memory 114 may be a flash memory) for storing application programs 116 and files 118, and a processor 120 electrically connected to the memory 114 for executing the application programs 116. The server 140 comprises a plurality of application programs 142. In addition, the PDA 110 further comprises a data transceiving module 121, and the server 140 further comprises a data transceiving module 143.

Some of the files 118 received by and stored in the PDA 110 can be opened/edited in the PDA 110 by application programs 116 which are installed in the PDA 110, but some files 150 can not. Please refer to FIG. 4 again. A PDA user can open/edit the file 150 by procedures described below.

The PDA user first inputs a string of user instructions 154 by using the input device 124. The file 150 is then sent from the data transceiving module 121 of the PDA 110 to the data transceiving module 143 of the server 140. After the server 140 receives the file 150, the file 150 is opened by an application program 142 that corresponds to the file 150 and the images 152 of the opened file 150 are then displayed on the display panel 122 of the PDA 110. By using the input device 124, the PDA user can edit the opened file 150 on the display panel 122. After the user finishes the editing, the user can save the updated file 150 in the memory 114 of the PDA 110 by a saving instruction 156. At the end, the user gives a closing command 158 to close the above operation. It should be noted that all the data/information, such as instructions and images, that are transferred between the PDA 110 and the server 140 are sent/received through the data transceiving module 121 of the PDA 110 and the data transceiving module 143 of the server 140.

In contrast to the prior art, the PDA using a remote server for processing can help a PDA user to open/edit files that can not be opened/edited in the PDA. The PDA user can open/edit the files in the PDA by using application programs that are installed in the remote server and correspond to the files.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A personal data assistant (PDA) connected to a server via a network, the server having a plurality of application programs, the PDA comprising:
a housing;
a memory installed in the housing for storing programs and data;
a processor electrically connected to the memory for executing the programs stored in the memory;
a display panel installed on the housing for displaying data; and
an input device for inputting data;
wherein the PDA is capable of sending a file to the server via the network, the server then opening the file using a corresponding application program and sending a picture image of the opened file back to the PDA.

2. The PDA of claim 1 wherein the PDA and the server each comprise a data transceiving module, the file being sent from the data transceiving module of the PDA to the data transceiving module of the server so that the server is capable of opening the file.

3. The PDA of claim 2 wherein when the server opens the file, the server will transmit the picture image via the data transceiving module of the server to the data transceiving module of the PDA so that the display panel is capable of displaying the opened file.

4. The PDA of claim 3 wherein when the server opens the file, a user is capable of using the input device to enter a user instruction, the user instruction being transmitted from the data transceiving module of the PDA to the data transceiving module of the server so that the server is capable of executing the user instruction, and then the server transmitting a picture image generated by executing the user instruction to the data transceiving module of the PDA from the data transceiving module of the server so that the display panel is capable of displaying the picture image.

5. The PDA of claim 2 wherein a user is capable of using the input device to enter a file back instruction, the file back instruction being transmitted from the data transceiving module of the PDA to the data transceiving module of the server, when receiving the file back instruction, the server transmitting the file back to the PDA via the data transceiving module of the server back and the data transceiving module of the PDA.

6. The PDA of claim 2 wherein a user is capable of using the input device to enter a file close instruction, the file close instruction being transmitted from the data transceiving module of the PDA to the data transceiving module of the server so as to make the server close the file.

7. The PDA of claim 1 wherein the network is an internet.

8. The PDA of claim 1 wherein the memory is a flash memory.
